(19) United States
(12) Patent Application Publication
(10) Pub. No.: US 2013/0270055 A1
(43) Pub. Date: Oct. 17, 2013

(54) ELECTRIC STARTING DEVICE OF MODEL ENGINE

(71) Applicant: Lien-Sheng CHANG, Taichung City (TW)

(72) Inventor: Lien-Sheng CHANG, Taichung City (TW)

(21) Appl. No.: 13/445,441

(22) Filed: Apr. 12, 2012

(51) Int. Cl. F16D 13/16

(52) U.S. Cl. 192/76

(57) ABSTRACT

An electric starting device of a model engine includes a motor, a transmission unit, a clutch and a connecting unit. The motor includes a first gear and a second gear. The clutch is disposed on a top surface of the first gear. The first gear includes limit posts on a circumferential surface thereof. The clutch includes clutch parts corresponding in number to the limit posts. The clutch parts have elongated through holes corresponding to the limit posts. The clutch includes a clutch cover pivotally connected with the second gear. The driving force of the motor is transmitted to the model engine through the clutch to enhance the starting capability of the model engine and to save electricity. When the feedback force of the model engine feeds back to the clutch, the clutch parts will disengage from the clutch cover to prevent the electric starting device from being damaged.

### BACKGROUND OF THE INVENTION

1. Field of the Invention

The present invention relates to an electric starting device of a model engine, and more particularly to an electric starting device to assist in starting the model engine.

2. Description of the Prior Art

Most remote-controlled model cars use gasoline or methyl alcohol as the power source of the model engine. The model engine uses an electric starting device to assist in starting the model engine of the remote-controlled model car. The electric starting device comprises a motor, a switch and a plurality of gears. The gears are a deceleration gear unit. When in use, the switch is turned on to start the motor. The motor drives the gears. Through the gears, the driving force of the motor drives the model engine.

Although the conventional electric starting device can assist in starting the remote-controlled model car, the model engine will feed back to the electric starting device in accordance with the principle of inertia at the moment that the electric starting device starts the model engine. The model engine generates a feedback force in the reverse direction relative to the driving force of the motor. When the driving force of the motor is less than the feedback force of the model engine, the feedback force of the model engine will turn the motor reversely. The feedback force of the model engine and the driving force of the motor will generate a pull. If there is no any member to decelerate or absorb the feedback force of the model engine, the motor and the deceleration gear unit may be damaged. The conventional electric starting device consumes a lot of electricity and it is not easy to start the model engine, so the product is not competitive. Accordingly, the inventor of the present invention has devoted himself based on his many years of practical experiences to solve these problems and to invent an electric starting device which buffers the feedback force of the model engine, prevents the motor and the deceleration gear unit from being damaged, has lower power consumption and starts the model engine with ease.

### SUMMARY OF THE INVENTION

The primary object of the present invention is to provide an electric starting device of a model engine which can buffer the feedback force generated by starting the model engine, preventing the motor and the deceleration gear from being damaged. The electric starting device of the present invention can lower the power consumption and can be started with ease.

In order to achieve the aforesaid object, an electric starting device of a model engine is provided. The electric starting device comprises a motor, a transmission unit, a clutch and a connecting unit.

The motor comprises a driving gear at an output end thereof.

The transmission unit comprises a first gear to mesh with the driving gear. The transmission unit further comprises a second gear. The first gear and the second gear are coaxial.

The clutch is disposed on a top surface of the first gear. The first gear comprises at least two limit posts disposed on a circumferential surface thereof and spaced equally. The clutch comprises clutch parts corresponding in number to the limit posts. The clutch parts have elongated through holes corresponding to the limit posts. The elongated through holes are slight larger than the limit posts. Two distances defined between two ends of each elongated hole and an axle center of the first gear are not equal. The clutch comprises a clutch cover. The clutch cover comprises an axle. The clutch cover is pivotally connected with the second gear through the axle. The bottom of the clutch cover has an opening to form an accommodation space therein. The limit posts and the clutch parts are accommodated in the clutch cover.

The connecting unit has one end connected to the model engine and another end pivotally connected to a connecting gear relative to the second gear.

The driving force of the motor is transmitted to the model engine through the clutch to enhance the starting capability of the model engine and to save electricity. When the feedback force of the model engine feeds back to the clutch, the clutch parts will disengage from the clutch cover to prevent the electric starting device from being damaged.

The driving force of the motor of the electric starting device of the present invention is transmitted to the model engine through the clutch to overcome the problems existed in the conventional electric starting device. The electric starting device of the present invention can lower the power consumption and can be started with ease. When the feedback force of the model engine feeds back to the clutch, the clutch parts will disengage from the clutch cover to prevent the electric starting device from being damaged.

### BRIEF DESCRIPTION OF THE DRAWINGS

FIG. 1 is a perspective view according to a preferred embodiment of the present invention;

FIG. 2 is a partial exploded view according to the preferred embodiment of the present invention;

FIG. 3 is an exploded view according to the preferred embodiment of the present invention;

FIG. 4 is a transverse sectional view according to the preferred embodiment of the present invention;

FIG. 5 is a partial sectional view according to the preferred embodiment of the present invention in an operation state; and

FIG. 6 is a partial sectional view according to the preferred embodiment of the present invention in another operation state.

### DETAILED DESCRIPTION OF THE PREFERRED EMBODIMENTS

Embodiments of the present invention will now be described, by way of example only, with reference to the accompanying drawings.

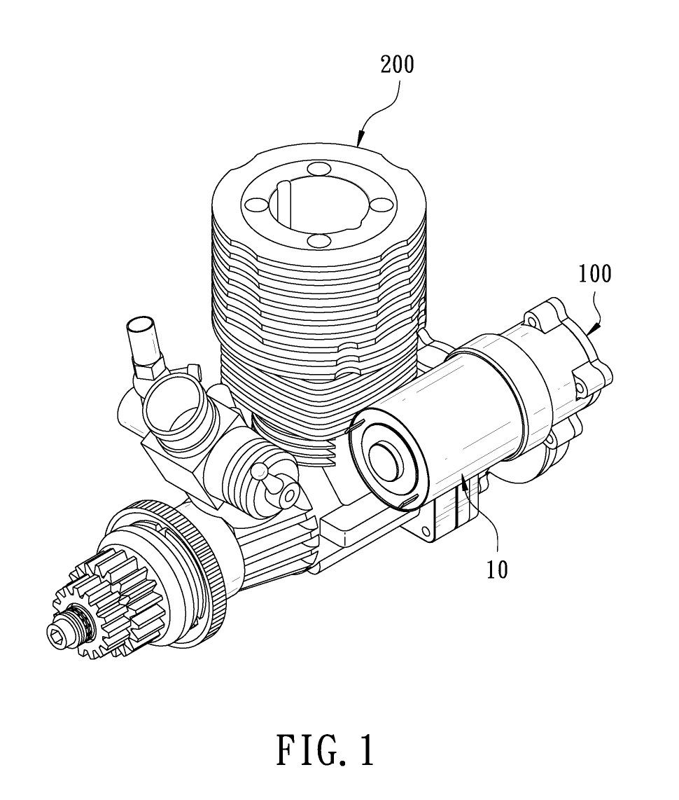

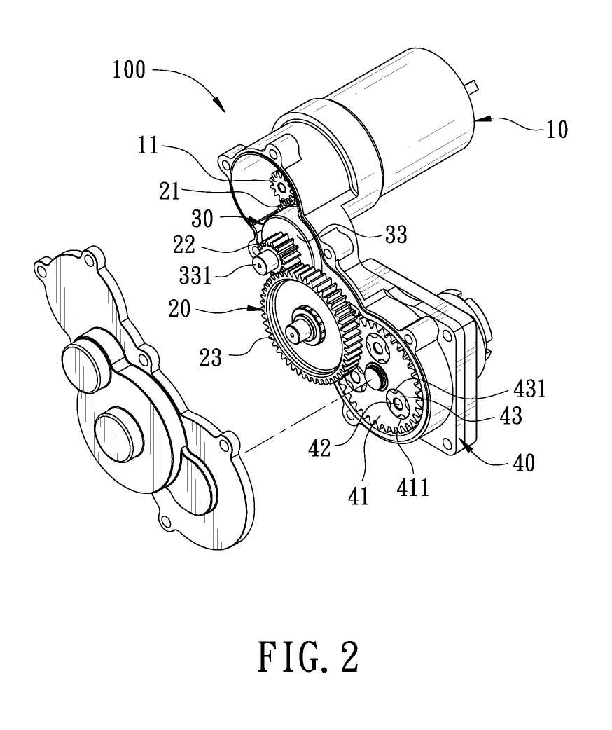

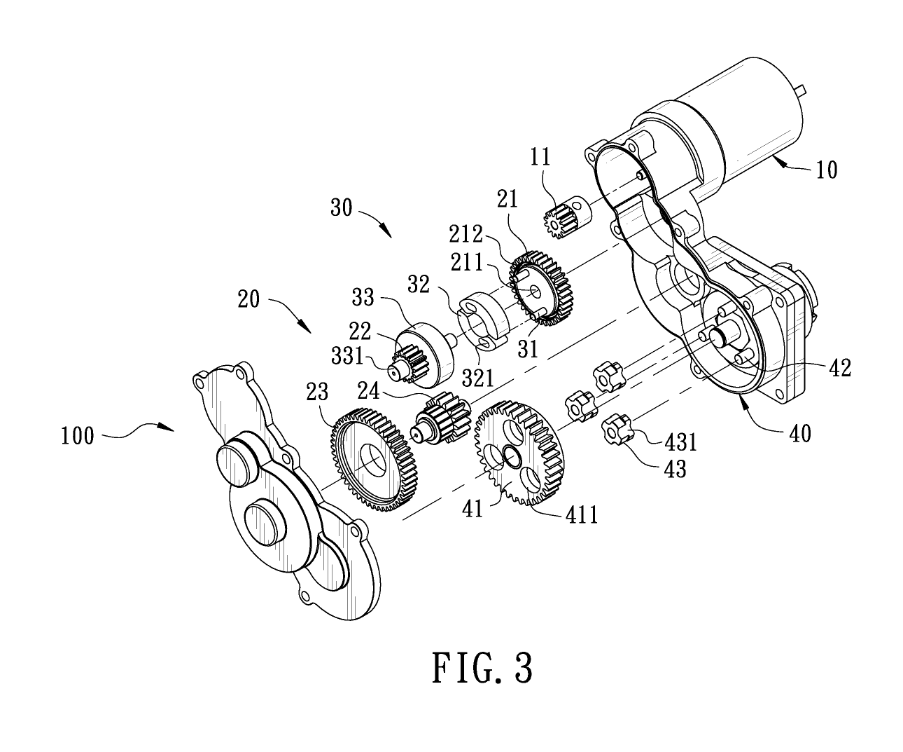

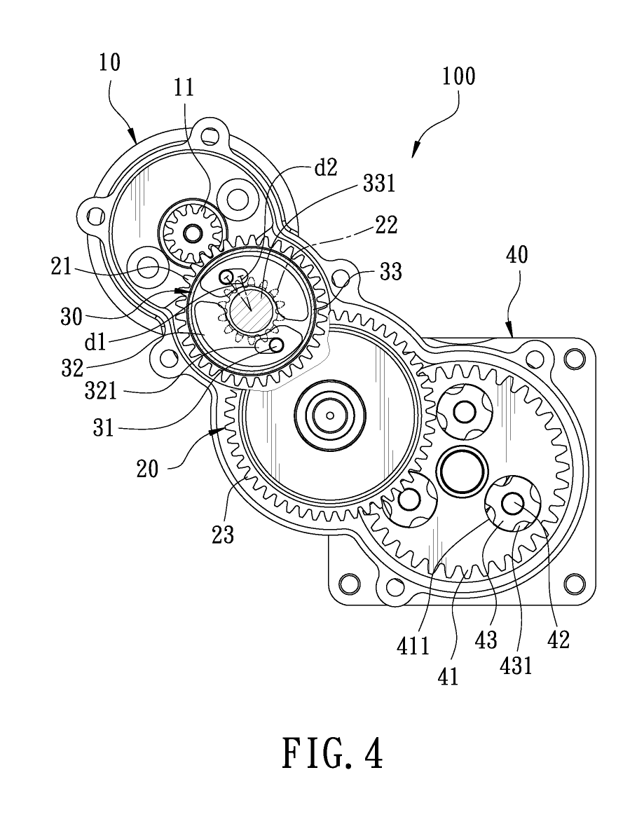

FIG. 1 is a perspective view according to a preferred embodiment of the present invention. FIG. 2 is a partial exploded view according to the preferred embodiment of the present invention. FIG. 3 is an exploded view according to the preferred embodiment of the present invention. FIG. 4 is a transverse sectional view according to the preferred embodiment of the present invention. One side of a model engine 200 is connected with an electric starting device 100. The electric starting device 100 comprises a motor 10, a transmission unit 20, a clutch 30, and a connecting unit 40.

The motor 10 comprises a driving gear 11 at an output end thereof.

The transmission unit 20 comprises a first gear 21 to mesh with the driving gear 11. The first gear 21 has a central axial hole 211 and a recess 212 on a top thereof. The transmission unit 20 comprises a second gear 22. The first gear 21 and the second gear 22 are coaxial. The transmission unit 20 comprises a third gear 23 to mesh with the second gear 22. The transmission unit 20 comprises a fourth gear 24. The third gear 23 and the fourth gear 24 are coaxial.

The clutch 30 is located between the first gear 21 and the second gear 22. The first gear 21 comprises two limit posts 31 disposed on a circumferential surface thereof and spaced equally. The clutch 30 comprises two clutch parts 32 corresponding to the two limit posts 31. The two clutch parts 32 have a curved shape. The two clutch parts 32 have elongated through holes 321 corresponding to the limit posts 31. The elongated through holes 321 are slight larger than the limit posts 31. Through the elongated holes 321, the clutch parts 32 are limited by the limit posts 31. In this embodiment, two distances defined between two ends of each elongated hole 321 and an axle center of the first gear 21 are not equal. A first distance d1 defined between one end of each elongated hole 321 and the axle center of the first gear 21. A second distance d2 defined between the other end of each elongated hole 321 and the axle center of the first gear 21. The first distance d1 is greater than the second distance d2. The clutch 30 comprises a clutch cover 33. The clutch cover 33 has a cylindrical wall which is contact with outer edges of the clutch parts 32. The bottom of the clutch cover 33 has an opening which faces the recess 212 of the first gear 21. The clutch cover 33 comprises an axle 331 corresponding to the axial hole 211 of the first gear 21. One end of the axle 331 is inserted in the axial hole 211 of the first gear 21. Another end of the axle 331 extends out of the top of the clutch cover 33. Through the axle 331, the clutch cover 33 is pivotally connected with the second gear 21. The clutch cover 33 has an accommodation space therein. The limit posts 31 and the clutch parts 32 are accommodated in the clutch cover 33.

The connecting unit 40 has one end connected to the model engine 200 and another end pivotally connected to a connecting gear 41 relative to the fourth gear 24. The connecting gear 41 meshes with the fourth gear 24. The connecting gear 41 has a plurality of through holes 411 which are equally spaced. The connecting unit 40 has a plurality of connecting posts 42 corresponding in position to the through holes 411 of the connecting gear 41. Between the through holes 411 and the connecting posts 42 are respectively provided with buffer pads 43. Each of the buffer pads 43 has a plurality of buffer spaces 431. The buffer pads 43 are made of a resilient material.

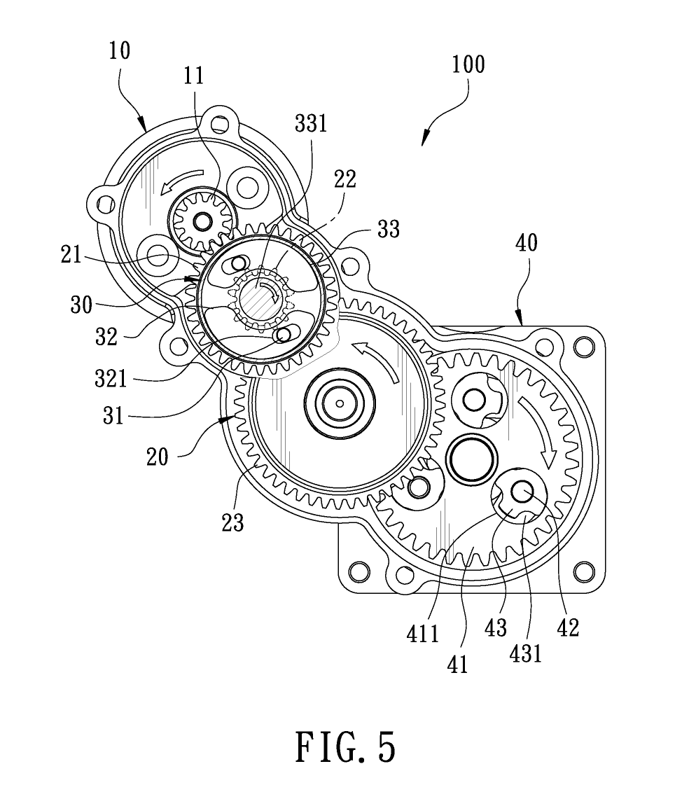

FIG. 5 is a partial sectional view according to the preferred embodiment of the present invention in an operation state. When the motor 10 starts, the driving gear 11 drives the first gear 21 to turn the limit posts 31 of the first gear 21. The limit posts 32 bring the clutch parts 32 to turn in the rotation direction of the first gear 21. The first distance d1 is greater than the second distance d2. One side of each clutch part 32 relative to the clutch cover 33 is pushed toward the inner wall edge of the clutch cover 33 to bring the clutch cover 33 through the contact frication. The driving force is transmitted to the second gear 22, the third gear 23, the fourth gear 24 and the connecting gear 41 in sequence. The connecting gear 41 transmits the driving force to the buffer pads 43. After receiving the driving force, the buffer pads 43 are pressed and deformed, and then the driving force is transmitted to the connecting posts 42 to drive the connecting unit 40 and the model engine 200 so as to start the engine.

Before the driving force of the motor 10 is transmitted to the model engine, the clutch parts 32 are moved toward the inner wall edge of the clutch cover 33. During this procedure, there is a time difference caused by the clutch parts 32 of the clutch 30 to be pushed toward the clutch cover 33. The motor 10 generates a slight idle running, not direct driving the load. By the buffer pads 43 to be pressed and deformed, the driving force is transmitted to the model engine 200. Accordingly, the motor 10 uses less electricity to drive the engine model 200. The electric starting device 100 of the present invention enhances the capability to start the model engine 200 and has an electricity-saving effect.

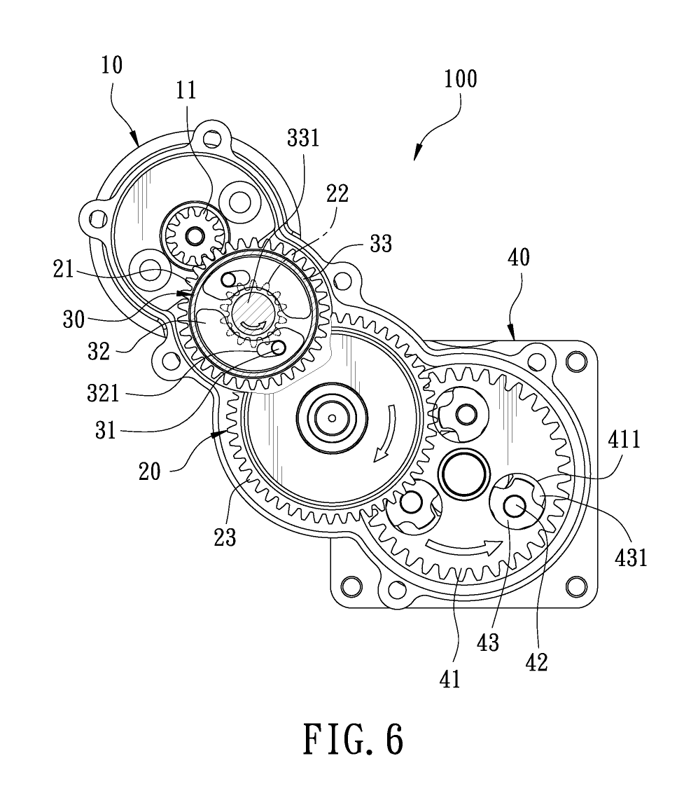

FIG. 6 is a partial sectional view according to the preferred embodiment of the present invention in another operation state. At the moment that the electric starting device 100 starts the model engine 200, the engine model 200 feeds back in accordance with the principle of inertia. In a circumstance that the driving force of the motor 10 is not larger than the feedback force of the model engine 200, the feedback force of the model engine 200 feeds back to the electric starting device 100. When the electric starting device 100 receives the feedback force of the model engine 200, the feedback force is first transmitted to the buffer pads 43. The buffer pads 43 pressed and deformed by the driving force of the motor 10 are restored, and then are pressed and deformed again by the feedback force to drive the connecting gear 41, the fourth gear 24, the third gear 23, the second gear 23 and the clutch cover 33 in sequence. The clutch cover 33 brings the clutch parts 32 to turn relative to the rotation direction the second gear 22. The first distance d1 is greater than the second distance d2. The clutch parts 31 are pushed away from the inner wall edge of the clutch cover 33 by the centrifugal force and the centripetal force, such that the clutch parts 31 are not contact with the clutch cover 33. Thus, the feedback force cannot be transmitted to the first gear 21 to protect the electric starting device 100. Before the feedback force is transmitted to the motor 10, the buffer pads 43 pressed and deformed by the driving force from the motor 10 are restored, and then are pressed and deformed again by the feedback force. Finally, the feedback force is transmitted to the clutch 30 and the clutch parts 32 disengage from the clutch cover 33, so the feedback force of the model engine cannot feed back to the motor 10. The buffer pads 43 can avoid the pull caused by the feedback force of the model engine and the driving force of the motor, preventing the motor 10 and the transmission unit 20 from being damaged.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An electric starting device of a model engine disposed at one side of the engine model, comprising:
a motor comprising a driving gear at an output end thereof;
a transmission unit comprising a first gear to mesh with the driving gear, the transmission unit further comprising a second gear, the first gear and the second gear being coaxial;
a clutch disposed on a top surface of the first gear, the first gear comprising at least two limit posts disposed on a circumferential surface thereof and spaced equally, the clutch comprising clutch parts corresponding in number to the limit posts, the clutch parts having elongated through holes corresponding to the limit posts, the elongated through holes being slight larger than the limit posts, two distances defined between two ends of each elongated hole and an axle center of the first gear being not equal, the clutch comprising a clutch cover, the clutch cover comprising an axle, the clutch cover being pivotally connected with the second gear through the axle, a bottom of the clutch cover having an opening to form an accommodation space therein, the limit posts and the clutch parts being accommodated in the clutch cover; and
a connecting unit having one end connected to the model engine and another end pivotally connected to a connecting gear relative to the second gear;
wherein, a driving force of the motor is transmitted to the model engine through the clutch to enhance the starting capability of the model engine and to save electricity, when a feedback force of the model engine feeds back to the clutch, the clutch parts disengage from the clutch cover to prevent the electric starting device from being damaged.

2. The electric starting device as claimed in claim 1, wherein a first distance is defined between one end of each elongated hole and the axle center of the first gear, a second distance is defined between the other end of each elongated hole and the axle center of the first gear, and the first distance is greater than the second distance.

3. The electric starting device as claimed in claim 1, wherein the connecting gear has a plurality of through holes which are equally spaced, and the connecting unit has a plurality of connecting posts corresponding in number to the through holes of the connecting gear.

4. The electric starting device as claimed in claim 1, wherein the first gear has a central axial hole, the axle of the clutch cover extending toward the first gear and inserted in the axial hole of the first gear.

5. The electric starting device as claimed in claim 3, wherein between the through holes and the connecting posts is provided with a buffer pad.

6. The electric starting device as claimed in claim 1, wherein the top surface of first gear has a recess relative to the opening at the bottom of the clutch cover.

7. The electric starting device as claimed in claim 5, wherein the buffer pad has a plurality of buffer spaces.

8. The electric starting device as claimed in claim 6, wherein the buffer pad is made of a resilient material.
